(19) United States
(12) Patent Application Publication
(10) Pub. No.: US 2004/0026027 A1
(43) Pub. Date: Feb. 12, 2004

(54) Method of applying a thermoset polymeric surface layer to noncellulose-based substrates and product of same

(76) Inventor: Jeffrey L. Walters, Ann Arbor, MI (US)

Correspondence Address: Hugo A. Delevie, BRINKS HOFER GILSON & LIONE, P.O. Box 10395, Chicago, IL, 60610, US

(21) Appl. No.: 10/464,008

(22) Filed: Jun. 18, 2003

Related U.S. Application Data
(60) Provisional application No. 60/389,566, filed on Jun. 18, 2002.

(51) Int. Cl. B32B 31/00

(52) U.S. Cl. 156/272.2; 156/275.5; 428/98

(57) ABSTRACT

A method for applying a thermoset polymeric surface layer to a noncellulose-based substrate, such as cement board or fiberglass-reinforced plastic panels, includes placing a resin-impregnated cellulose-based web material directly atop a prepared face of a selected substrate, whereupon the resinated web material is urged against the substrate face under heat and pressure to thereby permanently thermofuse the resinated web material on the substrate. The resulting, substantially-rigid, laminated panel includes a non-cellulose substrate with a thermoset resin face which can be used for a wide variety of decorative and functional purposes. A sublimatable ink may be transferred into the thermofused face when a polyester resin system is used in the cellulose web material.

### CROSS-REFERENCE TO RELATED APPLICATION(S)

This application claims the benefit of U.S. Provisional Application No. 60/389,566 filed Jun. 18, 2002.

### FIELD OF INVENTION

The invention relates to methods for applying a decorative and/or functional thermoset polymeric surface layer to a noncellulose-based substrate, such as cement board or fiberglass-reinforced plastic (FRP), to obtain a coated or laminated panel having a desired combination of surface and substrate characteristics.

### BACKGROUND OF THE INVENTION

The prior art teaches the application of a thermofused decorative and/or functional thermoset polymeric surface layer onto a cellulose-based “wood” substrate, thereby providing a substantially rigid panel used in such varied applications as decorative panels, walls, countertops, furniture and architectural building components, store fixtures and point-of-purchase displays, and a wide variety of automotive components, to name just a few applications. In a typical prior art thermofusing process, a cellulose web material saturated with selected B-staged thermosetting polyester or melamine resin, which may be either monochromatic (dyed) or suitably imprinted with a desired pattern or print, is laid directly upon a surface of the substrate. The layered web material and wood substrate are then subjected to heat and pressure between a pair of heated platens, for example, in the case of a polyester resin system, at up to 340° F. and at a pressure of perhaps 200 psi for as little as 35 seconds, such that the resin matrix flows toward and forms a bond with the substrate without the use of an independent adhesive. In the prior art, the “wood” substrate may be a monolithic piece of virgin wood or, in the alternative, a cellulose-based composite or engineered material such as particle board, medium-density fiberboard (MDF), or plywood, as selected depending upon the specific application for the resulting laminated panel. By way of example, plywoods manufactured with highly water-resistant adhesives are often selected as a preferred substrate material if the resulting laminated panel is intended for use in a marine environment, due to its desirable combination of weight and weather resistance.

Unfortunately, the moisture content of these cellulose-based substrates can deleteriously affect the thermofused process, for example, as where the application of heat and pressure releases steam from the substrate to thereby distort the applied surface layer. Further, the hydrophilic characteristics of such cellulose-based substrates can affect the performance of the resulting thermofused panel when the panel is introduced into a moisture-laden environment, for example, with possible dimensional instabilities (warping) and a potential for rotting. Further, the underlying wood substrate makes it unlikely that the resulting panel is able to achieve a Class A fire rating, due to its predominant cellulose content.

The prior art also teaches the use of noncellulose-based panels, including cement board and fiberglass-reinforced plastic (FRP), in building construction and in the manufacture of a wide range of components for use in vehicles, recreational products, and commercial furniture. Generally, these noncellulose-based panels are formed through use of a slurry including a matrix material (such as cement or a selected uncured polymer resin, respectively), reinforcement fibers and, perhaps, a binder, that is either pressure-molded or pinch-rolled to obtain a thin sheet substrate. In the case of cement board, because the prior art has generally viewed such panels as being susceptible to crushing when subjected to the range of pressures typically associated with the thermofusing of a decorative or functional polyester surface on wood or wood-composite substrates, the prior art has instead resorted to applying a monochromatic flow-coated polymer surface at ambient pressure. Dye sublimation is often thereafter employed to introduce color patterns in the resulting monochromatic surface layer. However, such flow-coated surfaces lack the hardness and wearability of their thermofused counterparts.

In the case of FRP, the prior art has employed a roll laminating process in which glue is spread on a pre-sheeted FRP stock material and tackified, whereupon the FRP stock material is jointly fed with a “C”-staged (fully polymerized) melanine/acrylic-resinated decorative paper through a pinch roller to thereby cause the decorative paper to adhere to the FRP stock material. Because the resinated paper is fully cured before the paper is brought into contact with the FRP stock material, the resin does not flow and, hence, does not serve to bond the resulting surface layer to the substrate, and the resulting panel continues to feature the structural properties of the original (relatively flexible) FRP stock material. Further, because the “C”-staged thermoset-and-thermoplastic resin in the resinated paper is typically not cured under pressure, the resulting surface layer similarly lacks the hardness and wearability of a heat-and-pressure-cured thermoset polymeric surface layer.

Accordingly, what is needed is a thermofusing process for applying a thermoset polymeric surface layer to a noncellulose-based composite substrate, such as cement board or FRP, to thereby provide a substantially-rigid laminated panel featuring surface and substrate characteristics that overcome the deficiencies of substantially-rigid prior art laminated panels..

### BRIEF SUMMARY OF THE INVENTION

It is an object of the invention to provide a method for making a substantially-rigid laminated panel featuring a thermosetting polymeric surface layer and a noncellulose-based substrate, such as cement board or FRP.

It is an other object of the invention to provide a substantially-rigid laminated panel having at least one thermosetting polymeric surface layer and a substrate material that is more water resistant than known cellulose-based substrates.

It is also an object of the invention to provide a substantially-rigid laminated panel that has both a thermoset polymeric surface layer and a Class A fire rating.

A further object of the invention is to provide a method for applying a thermosetting polymeric surface layer to a noncellulose-based substrate, such as cement board or FRP, which can thereafter be imprinted using dye sublimation process.

Yet another object of the invention is to provide a low-cost laminated panel having a noncellulose-based substrate and a decorative and/or functional polymeric surface layer.

Yet another object of the invention is to provide laminated panel featuring a noncellulose-based substrate, and a polymeric surface layer adapted to receive dye sublimation inks.

In accordance with the invention, a method of making a substantially-rigid laminated panel includes placing a cellulose web material, impregnated with a “B”-stage thermoset resin selected from the group consisting of polyester and melamine resins, directly against a first face of a thin, noncellulose-based substrate; and urging the resin-impregnated web material against the face of the substrate under heat and pressure to polymerize the resin and thereby bond the resinated web material directly to the substrate's first face.

Specifically, where the resin is a selected polyester resin, the resin-impregnated web material is urged against the substrate's first face, for example, by hot pressing between the heated platens of a hot press, at a nominal (platen) temperature in the range of about 265° F. to about 340° F. and, preferably, no greater than about 310° F., for a time and at a pressure sufficient to polymerize the resin. Under the invention, suitable times and pressures for making an exemplary panel with a polyester surface layer typically range from between about 30 seconds to perhaps 4 minutes, at pressures preferably ranging from between about 180 and about 250 psi (the necessary minimum cure time again being inversely related to the selected platen temperature).

Where the selected resin is a melamine resin, the resin-impregnated web material is urged against the substrate face at a nominal (platen) temperature in the range of about 300° F. to about 350° F., for a time and at a pressure sufficient to polymerize the melamine resin. Under the invention, suitable times and pressures for making an exemplary panel with a melamine surface layer typically range from between about 30 second to perhaps 4 minutes, at pressures of up to about 330 psi.

The polyester or melamine resin, which saturates the web material, may include UV protective additives, and abrasion resistant additives to thereby provide the surface layer of the resulting panel with a desired set of wear characteristics. Indeed, the additives may be incorporated within the resin of a further resin-impregnated light-weight cellulose web to thereby provide a cured surface with still greater abrasion resistance. In this event, the light-weight web, which is preferably impregnated with the same resin as the underlying web material, is laid on the outer face of the underlying web material prior to the thermofusing process, with the resin of each resin-impregnated web material thereafter being cured simultaneously.

Where the first face of the substrate includes, for example, surface irregularities or imperfections, the method further includes placing a cellulose web buffer sheet saturated with the same resin as that used in the surface layer to thereby provide sufficient face thickness to hide such irregularities or imperfections. Alternatively, where a textured or glossy surface layer is desired, the method preferably includes forming the textured or glossy surface on the surface layer during the urging step, for example, by placing a textured release sheet or a textured press plate against an exposed surface of the resin-impregnated web material within the hot press.

In accordance with another feature of the invention, a dyed or preprinted paper is advantageously used as a web material to thereby provide the resulting laminated panel with a decorative surface feature. Specifically, the web material is dyed or imprinted with one or more selected colors, patterns, and/or designs, to provide the cured and bonded surface layer of the resulting laminated panel with one or more desired decorative features. Alternatively, the method further includes imprinting the cured polymeric surface layer with one or more selected colors, patterns, and/or designs. By way of example, in an exemplary method, a polyester surface layer is imprinted by placing a paperbacked sublimatable ink against the cured polymeric surface layer, and applying heat in a range of about 350° F. to about 400° F. and a pressure of perhaps about 40 to 70 psi to thereby transfer the ink to the surface layer.

The invention advantageously provides a laminated panel featuring a decorative and/or functional thermosetting polymeric surface layer atop a noncellulose-based substrate. The resulting laminated panels are often lighter and more highly water-resistant than prior art “wood” based panels and, depending upon the cellulose content of the web material and the chemical composition of the noncellulose-based substrate, may advantageously feature a Class A fire rating.

In accordance with yet another aspect of the invention, where a melamine surface layer is to be applied to a relatively flexible noncellulose-based substrate, such as an FRP sheet, the surface layer is simultaneously thermofused to each of the substrate's exposed faces. In this manner, a substantially-rigid and durable laminated panel is produced while avoiding dimensional variation produced during melamine resin polymerization.

Because a polyester surface layer is far less likely to “pull” or warp a relatively-flexible substrate such as an FRP sheet during cure when using an appropriate time/temperature cycle, it will be appreciated that the invention advantageously produces a low-cost substantially-rigid, durable laminated panel (with or without a decorative appearance) when thermofusing a polyester surface layer to either one, or both, exposed surfaces of such a relatively-flexible noncellulose-based substrate.

Other objects and advantages of the invention will appear from the following description of the preferred embodiments.

### BRIEF DESCRIPTION OF THE DRAWINGS

FIG. 1 is a flow chart illustrating the main steps of an exemplary method for making a laminated panel in accordance with the invention;

FIG. 2 is a sectional view of a thin, flat substrate such as cement board, disposed between the platens of a hot press, with each face of the substrate being overlaid with plural layers of resin-impregnated web materials, immediately before the application of heat and pressure to thermofuse the resinated web materials to the substrate faces; and

FIG. 3 is an enlarged sectional view of the resulting exemplary laminated panel, after the thermofusing of the resinated web materials to each face of the substrate.

### DETAILED DESCRIPTION OF THE INVENTION

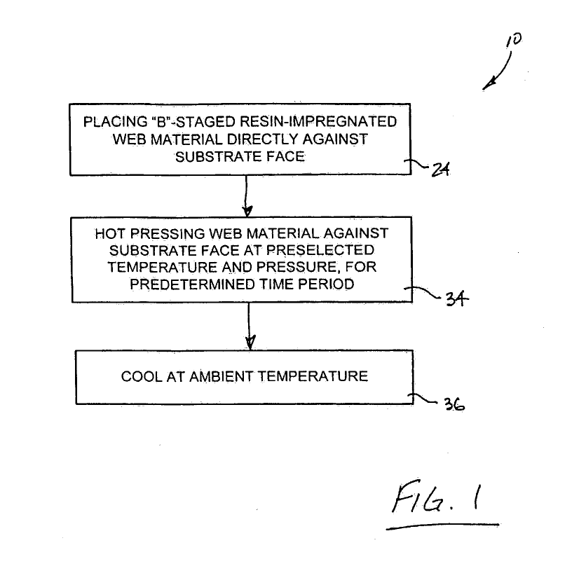

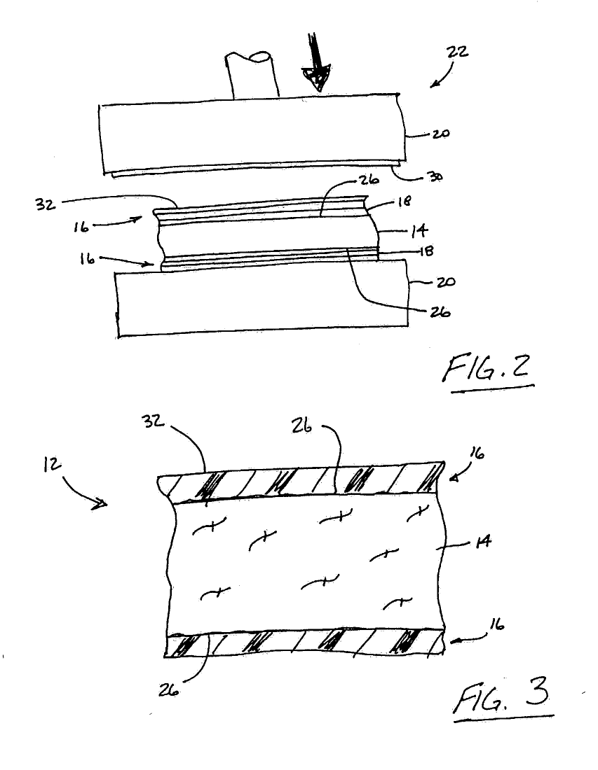

RAn exemplary method 10 in accordance with the invention for making a substantially-rigid laminated panel 12 having a noncellulose-based substrate 14 and at least one thermoset polymeric surface layer 16 is illustrated in FIG. 1. FIG. 2 illustrates a substrate and overlaid resinated web materials 18 between the platens 20 of a single opening hot press 22, immediately before closure. FIG. 3 is an enlarged sectional view of the resinating exemplary laminated panel 12. The phrase “noncellulose-based substrate 14” is intended to encompass substrates formed predominantly of materials that are noncellulose, for example, cement board or other mineral board (which might otherwise contain a relatively small amount of mineralized cellulose fiber), and plastic materials such as FRP. Where an improved fire rating is desired in the resulting laminated panel 12, the noncellulose-based substrate is either chosen to provide such an improved fire rating or, alternatively, in the case of certain noncellulose-based substrates such as FRP, the substrates are themselves formulated so as to qualify for an improved fire rating.

As seen in FIGS. 1-3, the exemplary method 10 includes, at step 24, placing at least one and, depending upon the desired surface characteristics of the resulting laminated panel 12, perhaps a plurality of resin-impregnated cellulose-base web materials 18 directly over one or both of the exposed faces 26 of the substrate 14. While the invention contemplates use of web materials 18 that are compatible with the selected resin 28, suitable alpha cellulose web materials generally have a preferred weight ranging between about 30 and about 160 g/m2, and most preferably having a weight less than about 130 g/m2 to reduce cost associated with a greater resin content associated with “heavier” web materials.

More specifically, the web material 18 can be either a pre-printed or dyed “decorative” paper that preferably weighs between about 60 and about 160 g/m2, or a light-weight web material which turns translucent when exposed to the appropriate heat and pressure during the thermofusing process and preferably weighs 30 g/m2 or less. Further, if the face 26 of the substrate 14 includes surface irregularities or imperfections that are not desired in the surface of the resulting laminated panel 12, a medium-weight web material 18 or “buffer sheet,” generally weighing perhaps 40 to 120 g/m2 and likewise saturated in the selected resin, is preferably first placed atop the exposed substrate face 26, beneath any other resin-impregnated web materials 18, thereby providing sufficient face thickness to hide such irregularities or imperfections. Thus, depending upon the desired decorative and functional characteristics of the resulting laminated panel 12, as well as the surface finish of the substrate face 26, a typical laminated panel 12 produced in accordance with the invention may have a thermofused surface layer 16 formed using only a decorative alpha-cellulose resin-impregnated paper by itself, or buffer sheets and/or overlays may also be used in various combinations to hide surface imperfections or irregularities (buffer sheets), to provide additional wear characteristics (overlays), and to provide an increased impact resistance (both buffer sheet and overlay).

In all cases, overlying layers of web material 18 are impregnated with the same thermoset resin 28 selected from the group consisting of polyester and melamine resins, whereupon the resinated web materials 18 are “B”-staged or partially cured to the point in which the resins 20 are dry to the touch but are only partially polymerized. For example, where a polyester resin system is selected for the resulting laminated panel 12, the web materials 18 or “papers” are saturated with polyester resins that are specially formulated for thermofusing. It is noted that suitable dyed or pre-printed polyester-resin-impregnated alpha-cellulose “papers” are available from Olon Industries of Geneva, Ill., while suitable dyed or pre-printed polyester- and melamine-resin-impregnated alpha-cellulose “papers” are available from the Pionite Division of Panolam Industries, of Auburn, Me.

As seen in FIGS. 2 and 3, the invention contemplates overlaying multiple layers of resinated web materials 18. Where one of the layers is a resin-impregnated pre-printed “decorative” paper as described above, the resinated decorative paper preferably forms one of the relatively “inner” layers of the laminated surface, while the “outermost” layer or layers of resin-impregnated web material preferably includes a relatively lightweight web to provide a clear overlay. The resulting laminated panels 12 are then suitable for use wherever decorative surfaced materials are required.

While the web material 18 is generally impregnated or “saturated” with an amount of resin 28 sufficient to provide a desired surface characteristic to the resulting laminated panel 12 while otherwise providing a desired bond between the surface layer 16 and the face 26 of the substrate 14, in making an exemplary panel 12, the selected “B”-staged (minimum polymerization) polyester or melamine resin preferably provides perhaps about 60 weight percent of the resinated web material. The polyester or melamine resin 28, which saturates the web material 18, may advantageously include UV protective additives, and abrasion-resistant additives such as aluminum oxide, to provide the resulting surface layer with a set of desired wear characteristics.

In order to facilitate adhesion of the surface layer 16 to the substrate 14, the face or faces 26 of the substrate 14 are preferably provided with a desired surface finish. By way of example, where the substrate 14 is cement board, the face 26 is preferably prepared by ensuring that the cement board has a nominal thickness to thereby avoid uneven surface pressure during hot pressing. Alternatively, the invention contemplates preparing the face or faces 26 of the substrate 14 by applying a filler material to selected portions of the substrate faces 26 to thereby achieve a desired nominal thickness for hot pressing. In this regard, it is noted that known processes for manufacturing cement board, such as that available from the Certainteed Corporation, generally provide the face of the cement board with small irregularities, to which the applied thermofused surface layers readily bond and, hence, surface roughening is not often required.

In contrast, where the substrate 14 is an FRP sheet produced, for example, by pinch rolling a slurry into a sheet prior to an ambient pressure cure at an elevated temperature, the substrate face 26 is preferably prepared for thermofusing by sanding with a belt sander of 80 to 120 grit material at a rate of about 50 feet per minute. It will be appreciated, however, that the invention contemplates use, for example, of textured pinch rollers or transfer sheets to thereby impart a desired surface finish to the face of an FRP substrate 14, thereby obviating any further surface preparation prior to overlaying the B-staged resinated web materials against the substrate faces 26. Other methods for preparing the substrate face 26 are also contemplated, including etching and laser scoring.

In accordance with another aspect of the invention, as seen in FIG. 2, a press plate 30 having a desired surface texture is disposed between the uppermost layer of resinated web material 18 and the platen 20 of the hot press 22 to thereby impart a like surface finish to the surface 32 of the resulting laminated panel 12. The imparted surface 32 may be either textured or glossy, depending upon press plate selection. In this regard, it will be appreciated that the press plate 30 may be formed of either a suitable metal, such as stainless steel or aluminum, or of a suitable thermoset resin, either of which is preferably alloy-plated or coated with a release agent to prevent adhesion of the cured resin. The surface of such press plates 30 are themselves textured in any suitable manner, for example, as by machining or etching. Alternatively, a release sheet (not shown) may be used to provide the desired surface texture and gloss.

Referring again to FIG. 1, the exemplary method 10 further includes, at step 34, hot pressing the resin-impregnated web materials 18 against the respective faces 26 of the substrate for a time sufficient to fully polymerize the resin 28 of the several web materials 18 to form a single polymeric surface layer 16 that is bonded directly to each substrate face 26. More specifically, as seen in FIG. 2, with the layered substrate 14 and resinated web materials 18 placed between the heated platens of a hot press, heat and pressure is applied for a predetermined time such that resin flows against the face 26 of the substrate 14 to bond the web materials 18 to the substrate 14 without the need for an additional glue line, as illustrated by the following examples:

### EXAMPLE 1

Two polyester-saturated sheets, including one decorative sheet and one buffer sheet, are simultaneously thermofused to one side of a cement board substrate having a nominal thickness of approximately 5/16 inches, by hot pressing at 200 psi and 310° F., for a time period of at least 2 minutes and 30 seconds.

### EXAMPLE 2

Two polyester-resin-saturated sheets, including one decorative sheet and one buffer sheet, are simultaneously thermofused to one side of a cement board substrate having a nominal thickness of approximately ½ inches, by hot pressing at 200 psi and 310° F., for a time period of at least 3 minutes.

### EXAMPLE 3

A single decorative polyester-resin-saturated sheet is thermofused to one side of an FRP substrate having a nominal thickness of about 0.060 inches, by hot pressing at 200 psi and 310° F., for a time period of at least 1 minute, but preferably not greater than about 1 minute and 45 seconds.

### EXAMPLE 4

Two polyester-resin-saturated sheets, including a decorative sheet and an overlay, are thermofused to one side of an FRP substrate having a nominal thickness of about 0.060 inches, by hot pressing at 200 psi and 310° F., for a time period of at least 1 minute and 30 seconds, but preferably not greater than about 2 minutes.

### EXAMPLE 5

A single melamine-resin-saturated sheet is thermofused to each face of an FRP substrate having a nominal thickness of about 0.090 inches by hot pressing at 300 psi and 310° F., for a time period of about 1 minute, but preferably not greater than about 1 minute and 30 seconds.

The resulting surface layer 16 is so well-adhered to the substrate 14 that the surface bond to the cement board or FRP substrate 14 is typically greater than the internal bond of the substrate materials themselves. When curing is complete, a hard, cross-linked thermoset surface is advantageously formed on the faces 26 of the substrate 14 that is both durable and waterproof. Other beneficial surface characteristics include increased scratch resistance relative to known flow-coated surfaces, as well as increased overall panel stiffness and impact resistance. As seen in step 36 of FIG. 1, the exemplary method 10 is completed as the resulting panel 12 is then removed from the press and allowed to cool, for example, at ambient temperature.

In accordance with another aspect of the invention, because the reinforcement fibers within a typical FRP sheet may be softened during the thermofusing process, particularly where a relatively longer cycle time is employed, an exemplary method for laminating an FRP substrate includes applying a nominal pressure to the laminated surface layer 16 of the resulting panel 12 for an additional minimum time period, during which the reinforcement fibers within the FRP substrate are permitted to once again harden. In this way, a possible distortion of the panel 12, including the possible lifting of portions of the laminated surface 16 due to the action of these softened reinforcement fibers, is avoided.

Once the dimensions of the resulting laminated panel 12 have stabilized, where desired, the invention contemplates the further step of imprinting the web material with one or more selected colors, patterns, and/or designs, to provide the cured and bonded surface layer of the resulting laminated panel with one or more desired decorative features. For example, a laminated panel 12 that has a cured polyester surface layer is readily imprinted by placing a paperbacked sublimatable ink against the surface layer, and applying heat in a range of about 350° F. to about 400° F. and pressure of perhaps about 40 to 70 psi to thereby transfer the ink to the surface layer.

While the above description discloses several preferred embodiments, it will be appreciated that the invention is susceptible to modification, variation and change without departing from the proper scope and fair meaning of the subjoined claims.

What is claimed is:

1. A method of making a substantially-rigid laminated panel including a thin, noncellulose-based substrate formed of a material selected from the group consisting of cement board and fiberglass-reinforced plastic, the method comprising:
placing a cellulose web material, impregnated with a “B”-stage thermoset resin selected from the group consisting of a polyester resin and a melamine resin, atop a first face of the substrate; and
urging the resin-impregnated web material against the face of the substrate under heat and pressure to polymerize the resin and bond the resinated web material directly to the first face of the substrate, whereby a polymeric surface layer is formed on the first face of the substrate.

2. The method of claim 1, wherein urging includes hot pressing the substrate and overlying resin-impregnated web material between the heated platens of a hot press.

3. The method of claim 2, wherein hot pressing includes heating the platens to a nominal platen temperature in the range of about 265° F. to about 350° F.

4. The method of claim 3, wherein the selected resin is a melamine resin, the resin-impregnated web material is urged against the substrate face at a nominal (platen) temperature in the range of about 300° F. to about 350° F.

5. The method of claim 2, wherein hot pressing includes platen pressures in a range of about 180 psi to about 250 psi.

6. The method of claim 1, further including placing a cellulose web buffer sheet saturated with the selected resin between the first face of the substrate and the resin-impregnated web material before the urging step, whereby the cellulose web buffer sheet and the resin-impregnated web material are bonded directly to the first face of the substrate during the urging step.

7. The method of claim 1, wherein urging further includes imparting a textured or glossy finish on an exposed face of the resin-impregnated web material during the urging step.

8. The method of claim 7, wherein imparting includes placing one of a textured release sheet and a textured press plate against an exposed face of the resin-impregnated web material during the urging step.

9. The method of claim 1, further including placing a light-weight web impregnated with the selected resin top the resin-impregnated web material before the urging step, whereby the light-weight web and the resin-impregnated web material are bonded directly to the first face of the substrate during the urging step.

10. The method of claim 1, further including preparing the first face of the substrate before placing the first resin-impregnated web material atop the first face of the substrate.

11. The method of claim 10, wherein preparing includes abrading a selected first surface portion of the first face of the substrate.

12. The method of claim 10, wherein preparing the first face of the substrate includes applying a filler material to a selected second surface portion of the first face of the substrate.

13. The method of claim 1, further including imprinting the polymeric surface layer after the urging step.

14. The method of claim 13, wherein imprinting includes placing a paperbacked sublimatable ink against the polymeric surface layer, and applying heat in a range of about 350° F. to about 400° F. and at a pressure of about 40 to about 70 psi, whereby the ink is transferred to the polymeric surface layer.

15. The method of claim 1, further including cooling at an ambient temperature after the urging step.

16. A substantially-rigid laminated panel comprising:
a thin noncellulose-based substrate selected from the group consisting of cement board and fiberglass-reinforced plastic, the substrate having a first face and a second face opposite the first face;
a polymeric surface layer bonded directly to at least one face of the substrate, the polymeric surface layer being formed of a thermoset resin selected from the group consisting of a polyester resin and a melamine resin, the polymeric surface layer having been cured under heat and pressure while atop the at least one face of the substrate.

17. The panel of claim 16, wherein the polymeric surface layer defines an exposed surface, and wherein a dye is imprinted in the exposed surface of the polymeric surface layer.

18. A substantially-rigid laminated panel comprising:
a thin noncellulose-based substrate formed of cement board, the substrate having a first face and a second face opposite the first face;
a first polymeric surface layer bonded directly to the first face of the substrate, the first polymeric surface layer being formed of a polyester thermoset resin, the first polymeric surface layer having been cured under heat and pressure while placed directly atop the first face of the substrate.

19. The panel of claim 18, wherein the first polymeric surface layer defines an exposed surface, and wherein a dye is imprinted in the exposed surface of the first polymeric surface layer.

20. The panel of claim 18, including a second polymeric surface layer bonded directly to the second face of the substrate, the second polymeric surface layer being formed of the polyester thermoset resin of the first polymeric surface layer, the second polymeric surface layer having been cured under heat and pressure while placed directly atop the second face of the substrate and simultaneously with the first polymeric surface layer.
